(19) United States
(12) Patent Application Publication
(10) Pub. No.: US 2009/0134836 A1
(43) Pub. Date: May 28, 2009

(54) DEVICES AND METHODS FOR ELECTRONIC DEVICE RECHARGING

(75) Inventors: HONG ZHAO, NAPERVILLE, IL (US); NAVEEN AERRABOTU, GURNEE, IL (US); ANTHONY D. HEBERT, BARTLETT, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/945,687

(22) Filed: Nov. 27, 2007

(51) Int. Cl. H02J 7/00

(52) U.S. Cl. 320/103

(57) ABSTRACT

Disclosed are devices and methods for regulating providing a charge via a charge receiving port of one device, the one device coupled to another device having a charge providing port. In one embodiment, the ports can be coupled by a cable. In another embodiment, the ports can be coupled wirelessly. The charge delivering device may regulate a charge providing process, controlled by a charge regulating controller of the charge providing device and based, for example, upon predetermined criteria. A charge regulating controller can disable the charging process, monitor the charge depletion rate, or the charging process may be based upon user established criteria. A charge regulating controller of the other device can regulate the charge accepting process. Each device may take on both roles, that is providing charge and receiving charge.

### FIELD

Disclosed are devices and methods for recharging a power source of an electronic device, and more particularly, recharging a power source of an electronic device from a power source of another electronic device, the recharging controlled by a charge regulating controller of the charge providing device and based upon predetermined criteria.

### BACKGROUND

Mobile communication device users oftentimes carry more than one device at a time. For example, a business person may carry two phones, one for business use and another for personal use. Another reason to carry more than one mobile communication device is that each device may operate under different mobile services or carriers. Different carriers provide varying service agreements, such as friends and family incentives. In this way, a user may chose to communicate on different mobile communication devices with certain other users for cost efficiency. A user may carry more than two mobile communication devices.

A mobile communication device is a portable device requiring a power source such as a battery. A user may find himself or herself using one device more than another device, and therefore may deplete the charge of the power source more quickly for that device. Aside from making telephone calls, mobile communication devices include features such as still and video cameras, video streaming and two-way video calling, email functionality, Internet browsers, music players, FM radios with stereo audio, and organizers. Moreover, a cellular user may download music and movies to their mobile communication device as well. Mobile commerce (M-commerce) is yet another functionality incorporated into the operations of mobile communication devices. A user may favor one device over the other for carrying out some or all of the above-mentioned functions. Accordingly, the available charge of a power source of one device may be substantially diminished while another device's charge remains at a higher level.

### BRIEF DESCRIPTION OF THE DRAWINGS

FIG. 1 depicts an electronic device that is a mobile communication device including a charge regulating controller, a charge receiving port, and a charge providing port;

FIG. 2 depicts two devices that are coupled so that a first device may deliver a charge to a second device; and

FIG. 3 is an embodiment of a flow chart to carry out a method of the charge regulating controller in delivering a charge.

### DETAILED DESCRIPTION

It would be beneficial were a user of more than one electronic device to have the ability to charge the power source of one electronic device from the power source of another electronic device. In this way, for example, if a user were to have available more than one device, for example a plurality of mobile communication devices, the user may transfer charge from one device's power source to the power source of another device, thereby enabling its continued use in the absence of a utility based charging opportunity. For example, it may be beneficial to use a charging cable between the two devices to transfer the charge under control of a charge regulating controller that may be either in software or hardware of the charge delivering and/or of the charge receiving device. It may also be beneficial to regulate a transferred charge based upon predetermined criteria and/or user defined criteria, allowing a user many options in charging a device.

Disclosed are devices and methods for regulating providing a charge via a charge receiving port of one device, the one device coupled to another device having a charge providing port. In one embodiment the ports can be coupled by a cable. In another embodiment the ports can be coupled wirelessly. The charge delivering device may regulate a charge providing process, controlled by a charge regulating controller of the charge delivering device and based, for example, upon predetermined criteria. As will be described below, a charge regulating controller can disable the charging process, monitor the charge depletion rate, or the charging process may be based upon user established criteria. A charge regulating controller of the other device can regulate the charge accepting process. Each device may take on both roles, that is providing charge and receiving charge.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

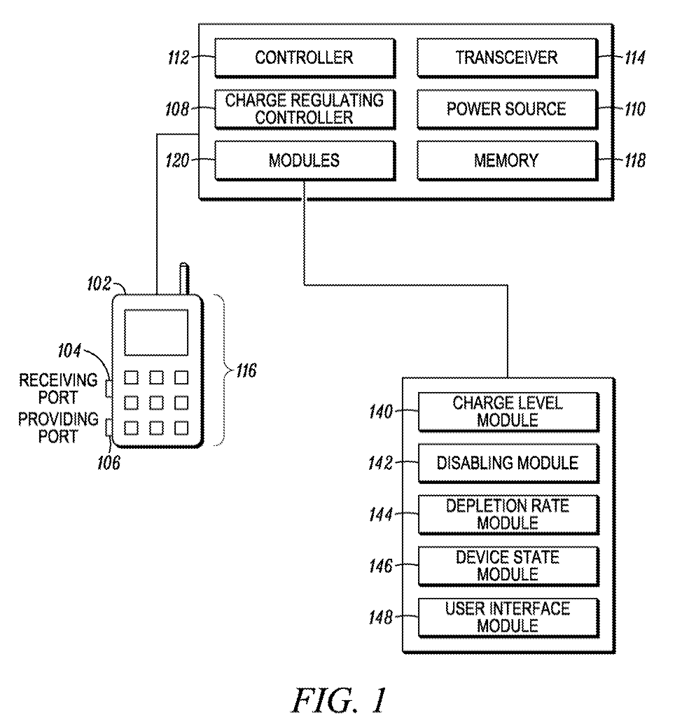

FIG. 1 depicts an electronic device that is a mobile communication device 102 including a charge regulating controller, a charge receiving port, and a charge providing port. Such a device is portable and reliant on a power source such as a battery. The depicted mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). It is understood that the electronic device may be of any type that may include a power source which from time to time may require a charge or re-charge, including but not limited to industrial or power tools, media playback devices, cameras and toys. It is further understood that any device including a power source such as a battery is within the scope of this discussion.

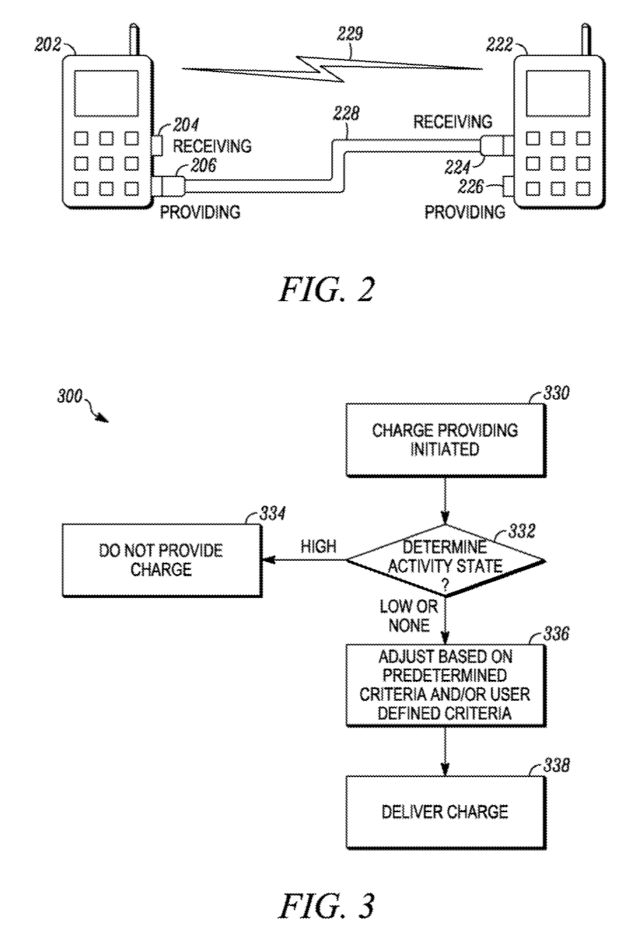

The depicted mobile communication device 102 in this example may include one or both a charge receiving port 104 and a charge providing port 106. As discussed above, it would be beneficial were a user to have available more than one device 102 to have the ability to charge the power source of the device 102 from the power source of another electronic device (see FIG. 2). In one embodiment, the first device 102 having a charge receiving port 104 can be coupled to a second device (see FIG. 2) having a charge providing port 106 similar to that shown in FIG. 1. The ports may be coupled by for example a cable (see FIG. 2). In another embodiment, the ports may be coupled wirelessly, for example, by inductive or magnetic coupling. It is understood that with an inductive charging configuration, the ports may be internal to the mobile communication device 102. It is further understood that appropriate circuitry is included with charge receiving port 104 and charge providing port 106 so that charge may be received by the device 102 and/or may be provided by the device 102. The regulating of the charging process is based in one embodiment upon predetermined criteria and controlled by a charge regulating controller 108 of the device 102.

The mobile communication device 102 includes a power source 110 such as a battery, a controller 112 that may be coupled to, incorporated with, or independent from a charge regulating controller 108. It is understood that the charge regulating controller 108 may be in any suitable configuration. A mobile communication device 102 may further include at least one transceiver 114. A user interface 116 may be used to establish at least one user defined predetermined criterion for either or both delivering a charge to another device or receiving a charge from another device.

A memory 118 may store modules 120 that are configured to execute instructions. For example, modules may include a charge level module 140, a disabling module 142, a depletion rate module 144, a device state module 146, and a user interface module 148. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

FIG. 2 depicts two devices that are coupled so that a first device 202 may deliver a charge to a second device 222 (devices 202 and 222 being similar to that shown as device 102 of FIG. 1) that may receive the charge to its power source 110 (see FIG. 1). Device 202 is depicted having both a charge receiving port 204 and charge providing port 206. Device 222 is depicted having both a charge receiving port 224 and charge providing port 226. It is understood that either of devices 202 and 222 may provide charge to the other device, and that either of the devices may receive charge from the other. Each port may receive, for example, a USB connector. It is understood that the each of the ports 204, 206, 224 and 226 may be configured to receive any type of connector. The connector cable 228 to couple the devices 202 and 222 may be any type of connector cable suitable to transmit the charge between device 202 and device 222. It is further understood that the ports 204 and 224 may be configured to accept a connection, for example a wired connection or a wireless connection, to receive charge, and that the ports 206 and 226 may be configured to accept a connection, for example a wired connection or a wireless connection, to provide charge. It is also understood that, although shown on the exterior of the devices 202 and 222, one or more of the ports 204, 206, 224, and 226 may be interior to the devices when the connection is wireless.

As mentioned above, the available charge of a power source 110 (see FIG. 1) of a device 222 may be substantially diminished while another device's 202 power source's charge remains at a higher level. Accordingly, a user may wish to increase the charge level of device 222. In the example of FIG. 2, the charge providing port 206 of device 202 may deliver charge to device 222 at its charge receiving port 224 via for example the cable 228, or via the wireless connection 229. Regulating providing a charge during the charging process is based upon predetermined criteria. The charge regulating controller 108 can regulate the charge providing process as well as the charge receiving process. For example, for providing a charge, the charge regulating controller 108 can disable the charging process, monitor the charge depletion rate of the power source 110 of device 202, or the charging process may be based upon user established criteria. Each device 202 and 222 may take on both roles, that is, providing charge and receiving charge.

As discussed, a charge regulating controller 108 (see FIG. 1) is configured to regulate a charge delivered via a charge providing port 206 based upon predetermined criteria. In one embodiment, predetermined criteria can be an established threshold value for the amount of charge of the power source 110 above which the device 202 will provide charge via the charge delivering port 206. The established threshold criteria may be executed in accordance with the charge level module 140 that can be configured to establish a threshold value for the amount of charge of the power source 110 above which the device 202 will provide charge via the charge providing port 206 as a predetermined criterion. In another embodiment or in addition to the previously discussed predetermined criteria, the predetermined criteria also may be when charge of the power source 110 is at least one of equal to and below the threshold value for the amount of charge of the power source 110, so that in accordance with the disabling module 142 stored in memory 118 the charge delivery may be terminated. Accordingly, the device 202 can be configured to disable providing charge via the charge providing port 206. In yet another embodiment, the depletion rate of the power source 110 may be determined by a depletion rate module 144 stored in memory 118 and configured to establish a depletion rate at or below which the device 202 will provide charge via the charge providing port 206 when the device 202 is drawing power from the power source 110 at a predetermined rate as a predetermined criterion. That is to say, even if the device 202 is drawing power from its own power source 110, it may still provide charge to another device 222 when the depletion rate of its power source 110 is below or the same as a predetermined rate. In still another embodiment, a device state module 146 stored in memory 118 is configured to control the charge regulating controller 108 to provide a charge via the charge providing port 206 based on when the device 202 is in an inactive state or a low activity state.

As mentioned above, the device 102 (see FIG. 1) includes a user interface 116. A user interface module 148 stored in memory 118 is configured to establish at least one user defined predetermined criterion via the user interface 116 to adjust at least one of magnitude, duration and availability of the charge the device will provide via the charge providing port 206. The charge regulating controller 108 may be configured to adjust providing charge via the charge providing port 206 based upon at least one user defined predetermined criterion. In this way the charge regulating controller 108 which is part of device 202 may control the amount of charge delivered to another device.

The predetermined criteria further may be used to establish conditions on accepting a charge via the charge accepting port 204, the conditions, for example, based on charge magnitude and charge duration. Additionally, the charge accepting port 204 may be configured via the user interface 116 to accept charge from another device. In this way the charge regulating controller 108 which is part of device 202 may control the amount of charge provided and/or received from another device.

FIG. 3 is an embodiment of a flow chart to carry out a method 300 of the charge regulating controller 108 in delivering a charge. Accordingly, if the available charge of a power source 110 (see FIG. 1) of one device, for example 222 (see FIG. 2) is substantially diminished while another device's 202 charge remains at a higher level charge providing 330 from device 202 may be initiated. The device state of 202 may be determined in accordance with a device state module 146 stored in memory 118 and configured to control the charge regulating controller 108 to provide a charge via the charge providing port 106 based on when the device is in an inactive state or a low activity state. Determining the activity state 332 may find device 202 in a high activity state 334 in which case providing charge from device 202 to device 222 may not be initiated. In this way, the activity of device 202 may not be compromised by power depletion. If it is determined 332 that the activity state of device 202 is low or it is inactive, the charge regulating controller 108 can adjust 336 the charge provided via the charge providing port 206 based upon the above-discussed predetermined criteria and/or user defined criteria. If conditions are met, the device 202 can deliver a charge 338 to device 222.

Accordingly, were a user of more than one electronic device to have the ability to charge the power source of one electronic device from the power source of another electronic device, the user may enable continued use of the depleted device in the absence of a utility based charge. Furthermore, a charge regulating controller that is either in software or hardware of the charge delivering and/or the charge receiving device provides the regulation of a transferred charge based upon predetermined criteria and/or user defined criteria, allowing many options for the user in charging a device.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device, comprising:
a controller;
a power source coupled to the controller;
a first port configured to accept a first connection configured to provide a charge to another device;
a second port configured to accept a second connection configured to receive a charge; and
a charge regulating controller coupled to the controller and configured to regulate a charge via the first port based upon predetermined criteria.

2. The device of claim 1, further comprising:
a memory coupled to the controller;
a charge level module stored in memory and configured to establish a threshold value for the amount of charge of the power source above which the device will provide charge via the first port as a predetermined criterion; and
a disabling module stored in memory and configured to disable providing charge via the first port when charge of the power source is at least one of equal to and below the threshold value for the amount of charge of the power source.

3. The device of claim 1, further comprising:
a memory coupled to the controller;
a depletion rate module stored in memory and configured to establish a depletion rate at which the device will provide charge via the first port when the device is drawing power from the power source at a predetermined rate as a predetermined criterion; and
a disabling module stored in memory and configured to adjust the depletion rate for providing charge via the first port when the device is drawing power from the power source at the predetermined rate.

4. The device of claim 1, further comprising:
a user interface coupled to the controller;
a memory coupled to the controller; and
a user interface module stored in memory and configured to establish at least one user defined predetermined criterion via the user interface to adjust at least one of magnitude, duration and availability of the charge the device will provide via the first port as a predetermined criterion,
wherein the charge regulating controller is further configured to adjust providing charge via the first port based upon at least one user defined predetermined criterion.

5. The device of claim 1, wherein the first port is a USB port.

6. The device of claim 1, wherein the second port is a USB port.

7. The device of claim 1, further comprising:
a memory coupled to the controller; and
a device state module stored in memory and configured to control the charge regulating controller to provide a charge via the first port based on when the device is in at least one of an inactive state or a low activity state.

8. The device of claim 1, wherein at least one of the first connection or the second connection is a wireless connection.

9. An electronic device, comprising:
a controller;
a power source coupled to the controller;
a charging port configured to accept a connection configured to provide a charge to another device; and
a charge regulating controller coupled to the controller and configured to regulate providing a charge via the charging port based upon predetermined criteria, the predetermined criteria including at least one of an established threshold for the amount of charge of the power source above which the device will provide charge via the charging port, and an activity rate at which the device will provide charge via the charging port when the device is drawing power from the power source at a predetermined depletion rate.

10. The device of claim 9, wherein the predetermined criteria further comprise:
at least one user defined predetermined criterion established via a user interface to adjust at least one of magnitude, duration and availability of the charge the device will provide via the charging port.

11. The device of claim 9 wherein the charging port is a USB port.

12. The device of claim 9 further comprising:
a charge accepting port configured to accept a second connection configured to receive a charge, wherein the charge accepting port is a USB port.

13. The device of claim 9, further comprising:
a memory coupled to the controller; and
a device state module stored in memory and configured to control the charge regulating controller to provide a charge via the charging port based on when the device is in an inactive state.

14. A method of an electronic device including a controller, a power source coupled to the controller, and a charging port configured to accept a connection configured to provide a charge to another device, the method comprising:
regulating providing a charge via the charging port based upon at least one of an established threshold for the amount of charge of the power source above which the device will provide charge via the charging port, and an activity rate at which the device will provide charge via the charging port when the device is drawing power from the power source at a predetermined depletion rate.

15. The method of claim 14, further comprising:
regulating providing a charge via the charging port based upon at least one user defined predetermined criterion established via a user interface to adjust at least one of magnitude, duration and availability of the charge the device will provide charge via the charging port.

16. The method of claim 14, further comprising:
regulating the controller to provide a charge via the charging port based on when the device is in an inactive state.

17. The method of claim 14, wherein the electronic device further comprises an accepting port configured to accept a charge from another device, the method further comprising:
regulating accepting a charge from another device based upon predetermined charge accepting criteria.

18. The method of claim 17, further comprising:
establishing conditions via a user interface on accepting a charge, the conditions based on charge magnitude and charge duration.

19. The method of claim 14, further comprising:
configuring the charging port via a user interface to accept a connection configured to accept charge from another device.
